(19) United States
(12) Patent Application Publication
(10) Pub. No.: US 2015/0025741 A1
(43) Pub. Date: Jan. 22, 2015

(54) OPERATING METHOD FOR AN ACTIVE SUSPENSION OF A MOTOR VEHICLE

(71) Applicant: Audi AG, Ingolstadt (DE)

(72) Inventor: Christoph MÜLLER, Oberthulba (DE)

(21) Appl. No.: 14/335,319

(22) Filed: Jul. 18, 2014

(30) Foreign Application Priority Data
Jul. 19, 2013 (DE) 10 2013 012 124

(51) Int. Cl. B60G 17/018

(52) U.S. Cl. CPC B60G 17/018
USPC 701/38

(57) ABSTRACT

In a method of operating an active suspension of a motor vehicle having a predetermined axle kinematics, the active suspension is controlled by a controller such that a desired yaw moment is generated by adjusting a roll angle of the motor vehicle. The desired yaw moment is a result of the change of the originally set toe-in and the originally set camber of wheels.

### CROSS-REFERENCES TO RELATED APPLICATIONS

This application claims the priority of German Patent Application, Serial No. 10 2013 012 124.8, filed Jul. 19, 2013, pursuant to 35 U.S.C. 119(a)-(d), the content of which is incorporated herein by reference in its entirety as if fully set forth herein.

### BACKGROUND OF THE INVENTION

The present invention relates to an operating method for an active suspension of a motor vehicle having a predetermined axle kinematics, which is controlled by a controller in such a way that a yaw moment is generated.

The following discussion of related art is provided to assist the reader in understanding the advantages of the invention, and is not to be construed as an admission that this related art is prior art to this invention.

It is known in the art to actively generate a yaw moment during the operation of a motor vehicle, for example, to affect or to improve the tracking or the directional stability of the vehicle. A yaw moment, i.e. a rotation of the vehicle about the vertical axis, may be generated in different ways.

With dynamic steering, a manual steering torque noticeable by the driver is generated; however, the magnitude of this intervention is limited by vehicle certification regulations. In some situations, the fact that the intervention can be felt by the driver is also seen as disadvantageous.

It is also known in the art to operate wheel brakes on one side in order to generate the desired yaw moment. However, such a braking action cannot be maintained over an extended time, since otherwise the efficiency would degrade and brake wear would increase, while additionally continuously generating heat.

It has also been proposed to apply a diagonal tension to an active suspension of a motor vehicle. However, this causes an increased load on the two diagonally opposed tensioned wheels, resulting in higher energy consumption. In addition, under these circumstances the grip of the motor vehicle is reduced, since the total transmitted power is reduced in an emergency stop.

All known methods or measures for generating a yaw moment have drawbacks, either because they cause increased energy consumption or are problematic for safety reasons.

It would therefore be desirable and advantageous to obviate prior art shortcomings and to provide an improved method for operating an active suspension of a motor vehicle, by which a yaw moment is generated that does not adversely affect either the energy consumption or the safety.

### SUMMARY OF THE INVENTION

According to one aspect of the present invention, in an operating method according to the invention, the active suspension is controlled by the controller which adjusts a roll angle which generates the desired yaw moment by way of the resulting change of the set toe-in and camber of the wheels.

According to the invention, this effect is used in conjunction with a suitable design of the axle kinematics of a suspension of a motor vehicle such that a yaw moment is generated by generating a roll angle. This effect is based on the fact that toe-in and camber or the preset course of toe-in and camber depend on ₜhe roll angle. This effect is based on the design of the axle kinematics and was originally implemented to stabilize the vehicle during highly dynamic maneuvers. The invention exploits this effect for another purpose, namely for generating a yaw moment which is adjusted automatically when generating the roll angle. With the method according to the invention, a roll angle that is independent of the actual lateral acceleration and independent of the driving situation is introduced by the active suspension. Preferably, the magnitude of the roll angle corresponds to the magnitude of the desired yaw moment. The method according to the invention has the advantage that a yaw moment can be established by using already existing actuators. Accordingly, the operating method of the invention can be particularly easily implemented. Various functions can be supported with the introduced yaw moment, for example, a controlled travel along a straight line or guidance along a lane center.

The method according to the invention has the advantage that the intervention from the controller, namely generating the roll angle and the yaw moment, remains unnoticed by the driver. In addition, the roll angle and the yaw moment can be generated continuously without creating adverse effects. Furthermore, the generation of the roll angle and the yaw moment advantageously does not adversely affect the safety and the energy efficiency.

Lastly, the operating method according to the invention can be easily implemented, since only a conventional active suspension is required, which typically includes an air suspension and active stabilizers.

In an advantageous implementation of the operating method according to the invention, the roll angle may be produced by adjusting vertical forces between the wheel carrier and the chassis, wherein the vertical forces on the right side and the left side have different magnitudes. These vertical forces between wheel carrier and chassis are according to the method of the present invention generated by the active suspension. The active suspension has for this purpose actuators, such as an air suspension, active stabilizers and the like.

According to an advantageous feature of the present invention, generating the yaw moment may be triggered by a driver assistance system, in particular by a straight-line program or a lane-center guide. The driver assistance system can thus trigger the generation of the yaw moment according to the invention by setting the roll angle.

According to another advantageous feature of the present invention, the magnitude of the roll angle may be 0.5° to 1.5°; preferably, the roll angle is approximately 1°. This comparatively small roll angle is sufficient to produce the desired yaw moment.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a motor vehicle configured for implementing the operating method according to the present invention;

FIGS. 2 and 3 show the dependence of the toe angle on the spring travel;

FIG. 4 shows the forces acting on the wheels at a roll angle of 0°; and

FIG. 5 shows the wheel forces acting on the wheels at a roll angle of 5°.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

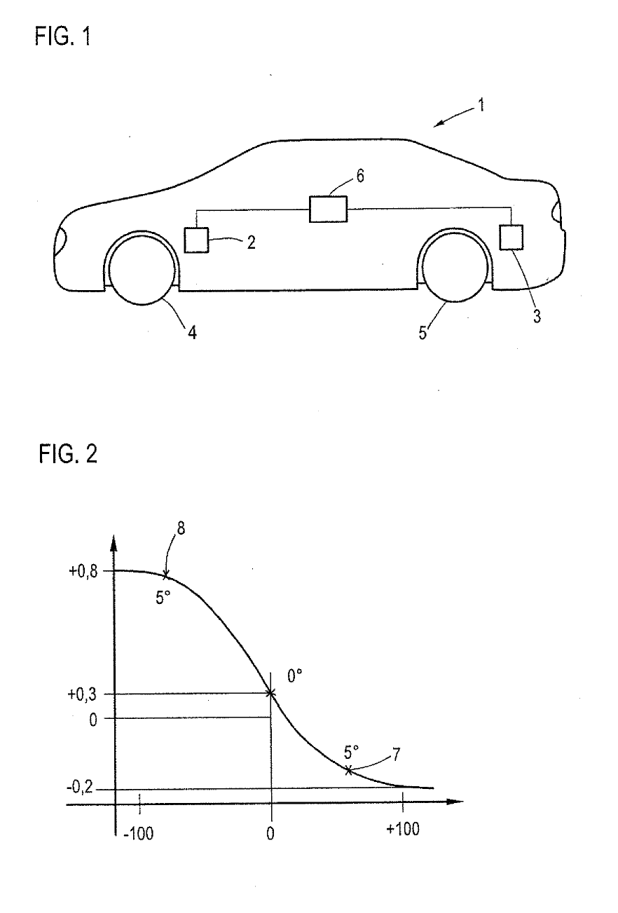

Turning now to the drawing, and in particular to FIG. 1, there is shown a motor vehicle having an active suspension with actuators 2, 3, which are constructed to affect the suspension and damping of the wheels 4, 5 of the motor vehicle 1. Each actuator 2, 3 includes a pneumatic or hydro-pneumatic cylinder producing a desired spring behavior. In addition, a controllable vibration damper is provided to convert vibration energy into heat.

The actuators 2, 3 of the active suspension are coupled to a controller 6, which controls the actuators 2, 3.

The motor vehicle 1 has a driver assistance system in the form of a lane-center guide. When the driver assistance system detects that a yaw moment is required for influencing the driving performance, it activates the controller 6. The controller 6 controls the actuators 2, 3 associated with the wheels 4, 5, so as to set, i.e. produce, a roll angle. It will be understood that the controller 6 is coupled with all four wheels of the motor vehicle 1, so that all four wheels contribute to the generation of the desired roll angle. This intentional intervention and control of the active suspension by way of the actuators 2, 3 produces a roll angle, i.e. a rotary motion of the motor vehicle 1 about its longitudinal axis. In the illustrated embodiment, the roll angle is 1°.

The kinematics of the active suspension of the motor vehicle 1 is designed so that a generated roll angle automatically generates a yaw moment. This effect is caused by the set toe-in and the set camber of the wheels 4, 5. The yaw moment generated by the generated roll angle is so small that it is not perceived at all by the driver or is at least not perceived by the driver as a nuisance.

With this method, the driving behavior of the motor vehicle 1 can be intentionally influenced by controlling the active suspension with a driver assistance system. The driver assistance system thereby activates the controller 6, which in turn influences the actuators 2, 3 of the wheels 4, 5.

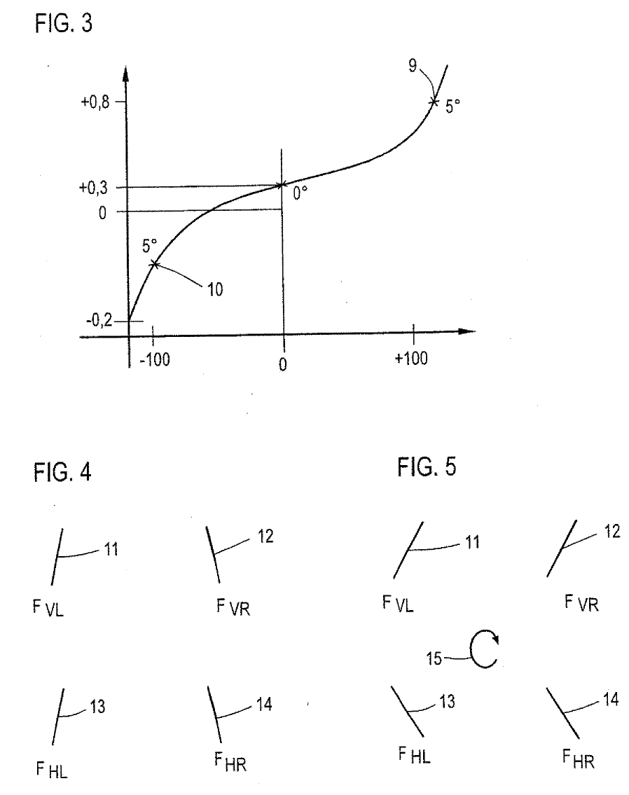

FIGS. 2 and 3 show the course of the toe angle as a function of the spring travel, wherein FIG. 2 shows this relationship for the front axle and FIG. 3 shows this relationship for the rear axle.

FIG. 2 shows on the x-axis, starting from a neutral state where no spring travel occurs, a range from +100 mm to −100 mm. A positive spring travel means that the spring is compressed on the wheel. Conversely, a negative spring travel means that the spring is extended, i.e. relaxed. The toe-in, more specifically the toe angle, is plotted on the vertical axis. In the absence of spring travel, the toe-in in the illustrated embodiment is 0.3°. In this situation, the roll angle is 0°. Starting from this neutral position, two points are shown in FIG. 2, corresponding to a roll angle of +5°. The point 7 is assigned to the right wheel, while the point 8 is assigned to the left wheel. As seen in FIG. 2, a particular toe-in is associated with each spring travel situation, while in turn a certain roll angle is associated with each variable pairs consisting of spring travel and toe-in. Increasing or reducing the spring travel causes a change in the toe-in and thereby a change in the roll angle— The region for the roll angle shown in FIG. 2 is with values between 0° and 5° very large; however, in practice a change in the roll angle of about 1° is sufficient to cause the desired effect of generating a yaw moment.

FIG. 3 is a diagram similar to FIG. 2, with FIG. 3 illustrating the relationship between spring travel and toe angle for the rear axle. It is evident from FIG. 3 that, starting from a neutral position, a positive spring travel causes an increase in the toe angle, and commensurately a roll angle; the roll angle at point 9 is 5°. Conversely, a negative spring travel causes a reduction of the toe angle, with point 10 corresponding to a roll angle of 5°.

FIGS. 4 and 5 show the effect of a change in the roll angle. FIG. 4 shows schematically the four wheels 11, 12, 13, 14 of a vehicle. When the roll angle is 0°, the lateral forces F_{fl} and F_{fr} acting on the wheels 11, 12 are equal in magnitude, but have opposite directions. Likewise, the lateral forces Fₕₗ and Fₕᵣ acting on the wheels 13, 14 of the rear axle are equal in magnitude and have opposite directions. These lateral forces are caused by the toe angle and are in turn dependent on the spring travel, as shown in FIGS. 2 and 3. In the situation shown in FIG. 4, all the lateral forces cancel each other, the roll angle is 0°, an no yaw moment is present as a result.

FIG. 5 is a diagram similar to FIG. 4, showing the acting lateral forces for the respective wheels 11, 12, 13, 14. To produce a positive roll angle of for example 5°, the suspension is controlled so that the left side rebounds and the right side is compressed. This results in a larger toe angle for the wheel 11 (front left). A larger toe angle is also obtained for the wheel 12 (front right). The wheel 13 (back left) has a smaller toe angle, likewise the wheel 14 (back right). The yaw moment is the sum of the forces acting on the wheels 11, 12, 13, 14, each multiplied by the respective effective lever arm. Accordingly, for a roll angle of +5°, the yaw moment 15 is obtained as a result of the applied roll angle and the associated resulting toe angle.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for operating an active suspension system of a motor vehicle having a predetermined axle kinematics, the method comprising:
adjusting with a controller of the motor vehicle a roll angle of the motor vehicle, said adjusted roll angle causing a change in a preset toe-in and a preset camber of the wheels, and
generating with the changed toe-in and the changed camber of the wheels a desired yaw moment of the motor vehicle.

2. The method of claim 1, wherein the roll angle is adjusted by setting vertical forces between a wheel carrier and a vehicle chassis, wherein the vertical force of the right-hand side of the motor vehicle has a different magnitude from the vertical force of the left-hand side of the motor vehicle.

3. The method of claim 1, wherein the desired yaw moment is triggered by a driver assistance system.

4. The method of claim 3, wherein the driver assistance system comprises a straight-line program or a lane-center guide, or both.

5. The method of claim 1, wherein the roll angle has a magnitude between 0.5° and 1.5°.

6. The method of claim 1, wherein the roll angle has a magnitude of approximately 1°.
